(19) United States
(12) Patent Application Publication
(10) Pub. No.: US 2002/0077956 A1
(43) Pub. Date: Jun. 20, 2002

(54) Method for providing in-transit authentication, repair and customization of auctioned goods

(75) Inventor: John K. Solheim, Phoenix, AZ (US)

Correspondence Address: John D. Titus, GALLAGHER & KENNEDY, P.A., 2575 East Camelback Road, Phoenix, AZ, 85016-9225, US

(73) Assignee: Karsten Manufacturing Corporation

(21) Appl. No.: 09/738,562

(22) Filed: Dec. 15, 2000

(51) Int. Cl. G06F 17/60

(52) U.S. Cl. 705/37; 705/26

(57) ABSTRACT

The present invention comprises a method of selling services consisting of authentication, repair and/or custom fitting services for an item sold by a seller to a bidder through an on-line auction. The web page of the auctioneer displays information indicating that the bidder may request that the auctioned item(s) be authenticated, repaired and/or custom fitted in transit from the seller to the bidder (or other services performed on the goods in transit). In an illustrative embodiment of the invention, a button is displayed on the web site of the on-line auction. The button is hyperlinked to the web site of the manufacturer, which enables the manufacturer to collect information necessary to effectuate the in-transit services.

### FIELD OF THE INVENTION

This invention relates to electronic commerce. Specifically, this invention relates to methods for marketing services via the internet or other interactive computer network.

### BACKGROUND OF THE INVENTION

With the increasing popularity of the internet and the worldwide web, it has become common for individuals wishing to sell used merchandise, collectibles, and other items to do so through on-line auctions. One example of a website that conducts an on-line auction is the popular eBay website, www.ebay.com. In a typical on-line auction, before a user can post an item for sale or bid on an item, the user must register with the auction site. Typically the auction site server delivers a webpage that contains an interactive form to the client system of the user. The user fills out the form, which is thereafter submitted to the auction site, to create a unique record for the user. When the user wishes to sell an item, the auction site verifies that the user is a registered user and thereafter provides the user with an interactive form for posting information regarding the item to be auctioned. Typically, the form has spaces for providing information including, for example, a description of the item, acceptable payment methods and whether or not the item carries a reserve and if so, the amount of the reserve. A program takes information from the interactive form and automatically creates a webpage on the auction site that describes the item for sale.

When a potential bidder sees the webpage and wishes to bid on the posted item, the bidder makes a bid by filling out an interactive form. The bid information is then used to update the auction record in the auction site database, which permits the webpage describing the auction item to be updated to reflect the new bid. Each time a new bid is placed, the database is updated to reflect the most current bid. When the auction closes, the database checks to see which bidder was the highest bid. The auction site server then automatically sends an email to the highest bidder notifying him or her that the winning bid was theirs and providing contact information for the seller. The auction site server also sends an email to the person selling the item giving that person the name and contact information for the highest bidder. In some cases, the auction site acts as an escrow collecting funds from the highest bidder and forwarding them to the seller on confirmation from the bidder that the auctioned items have been received. In other cases, payment and delivery of the goods are arranged privately between the seller and the bidder.

Because it is difficult for potential bidders to physically inspect items being offered for sale over an on-line auction, on-line authentication services have become available. These authentication services inspect the merchandise prior to its being offered for sale (either physically or photographically) and provide an opinion as to the authenticity and/or condition of the items being offered for sale. The providers of the on-line authentication services generally provide only an opinion as to authenticity prior to the transaction. They do not inspect the goods after they have been sold in order to guarantee the authenticity prior to receipt by the winning bidder. Use of on-line authentication services is also generally limited to collectible memorabilia, autographs, and trading cards.

High-end sports equipment such as used golf clubs are frequently posted for sale on online auction sites. As with sports memorabilia, it is important for the purchaser of used golf clubs to ensure that he or she receive genuine articles. Moreover, since high-end golf clubs are ordinarily fitted to the user based on the user's height, distance from wrist to floor, hand length, finger length, and other factors, a convenient way of having used clubs adjusted it would be of benefit to consumers who purchase golf clubs through on-line auctions. Accordingly, what is needed is an authentication and custom fitting service that can be ordered as part of the on-line bidding process and effected as the clubs are shipped from the seller to the buyer.

### SUMMARY OF THE INVENTION

The present invention comprises a method of selling authentication, repair and/or custom fitting services for an item sold by a seller to a bidder through an on-line auction comprising displaying on the client system of a bidder a webpage containing information indicating that the bidder may request that the item(s) be authenticated, repaired and/or custom fitted in transit from the seller to the bidder (or other services performed on the goods in transit). In an illustrative embodiment of the invention the items being sold are used golf clubs. A button is displayed on the website of the on-line auction describing the clubs that are for sale. The button is hyperlinked to the website of the golf club manufacturer, for example, Ping, Inc. (www.pinggolf.com). The manufacturer's website recognizes the hyperlink comes from a webpage provided by the on-line auction and in response to the link, transmits an interactive form to the bidder's computer. The bidder enters information such as the model and serial number of the clubs being offered for sale, the user's height, wrist-to-floor length, hand length, finger length, desired services and any other pertinent information into the form. Upon submission of the interactive form, the manufacturer's server provides an estimate as to whether the clubs in question can be fitted to the bidder and, if so, the cost of performing the fitting, repair and authentication services. Armed with this information, the bidder can make a more informed decision as to whether to bid on the clubs being auctioned and if so, how much to bid. If, after the auction closes, the bidder is determined to be the high bidder, the bidder is notified that he or she is the high bidder. The seller is provided with the identity of the high bidder and also advised that the successful bidder has elected to have the goods shipped to the manufacturer for authentication and service. Additionally, the seller is provided with the appropriate shipping address for the manufacturer. In the illustrative embodiment, the manufacturer also acts as the escrow receiving the funds from the successful bidder (e.g. purchase price plus the cost of certification, repair and fitting, plus shipping costs) and forwards the appropriate amount to the seller upon receipt and inspection of the goods. The availability of a manufacturer to provide intransit authentication, repair and custom fitting of used golf clubs enables consumers to avail themselves of on-line auctions, bidding with confidence, knowing that the clubs they receive will be the genuine article and will be appropriately fitted to their physique and capabilities.

The present invention will be better understood from a reading of the following detailed description, taken in conjunction with the accompanying drawing figures in which like references designate like elements and, in which:

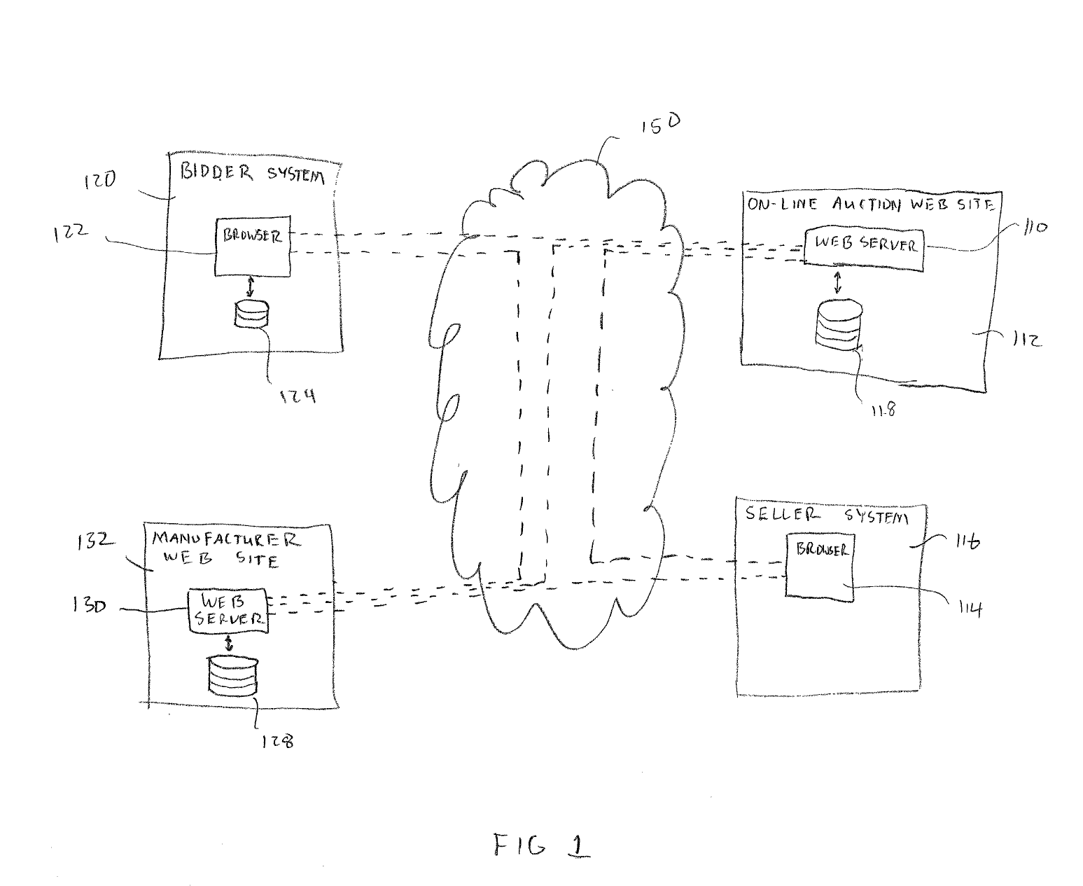

FIG. 1 is a high-level architectural drawing illustrating the primary components of a system operating in accordance with the present invention;

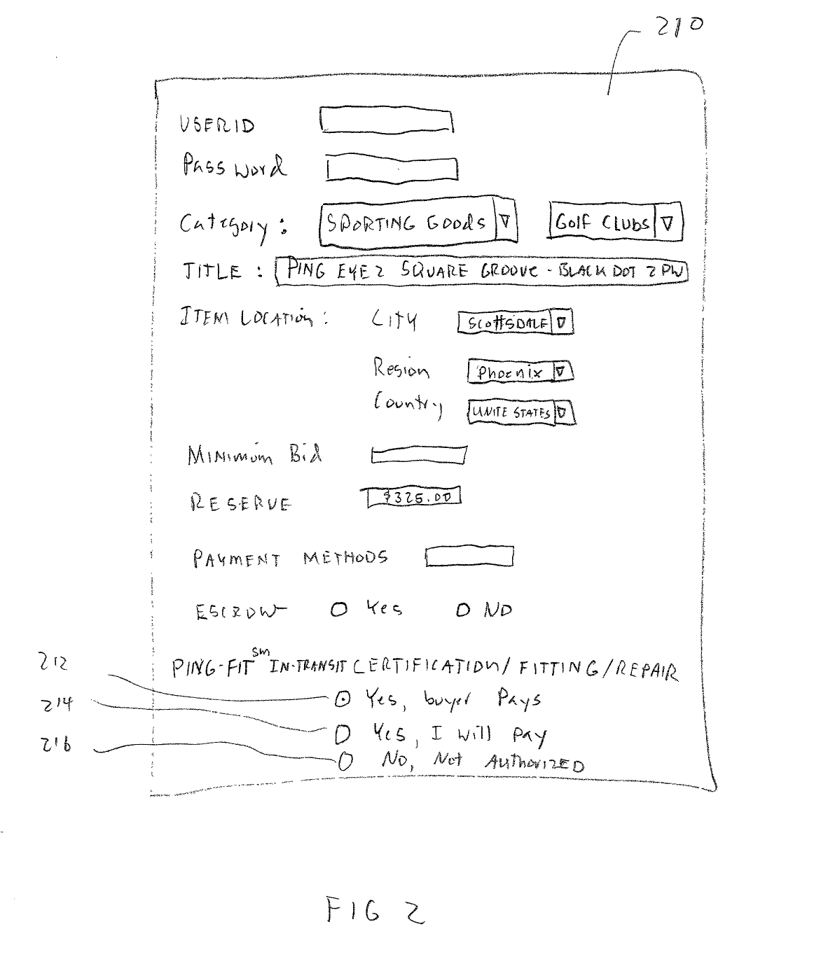

FIG. 2 is an illustration of a webpage displayed on the client system of a seller posting an item for sale in accordance with the present invention.

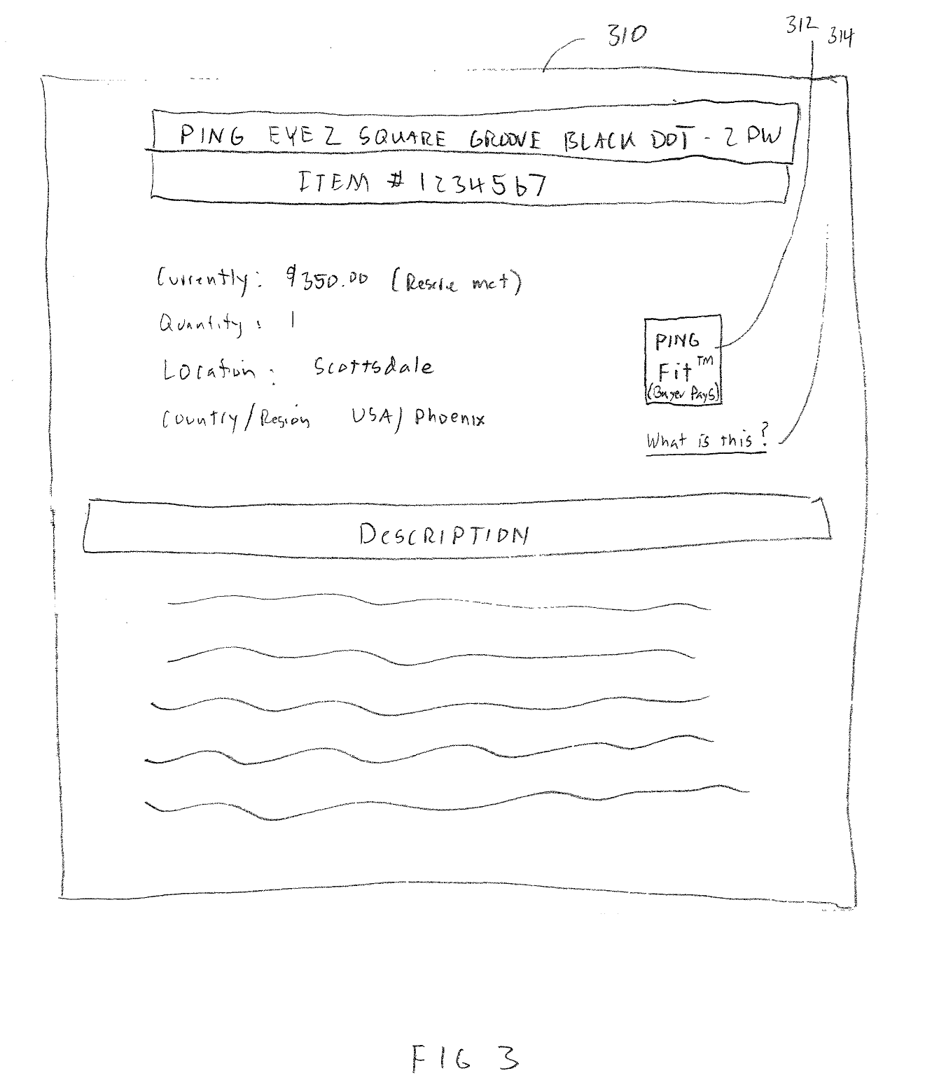

FIG. 3 is an illustration of a webpage displayed on the client system of a potential bidder in accordance with the present invention.

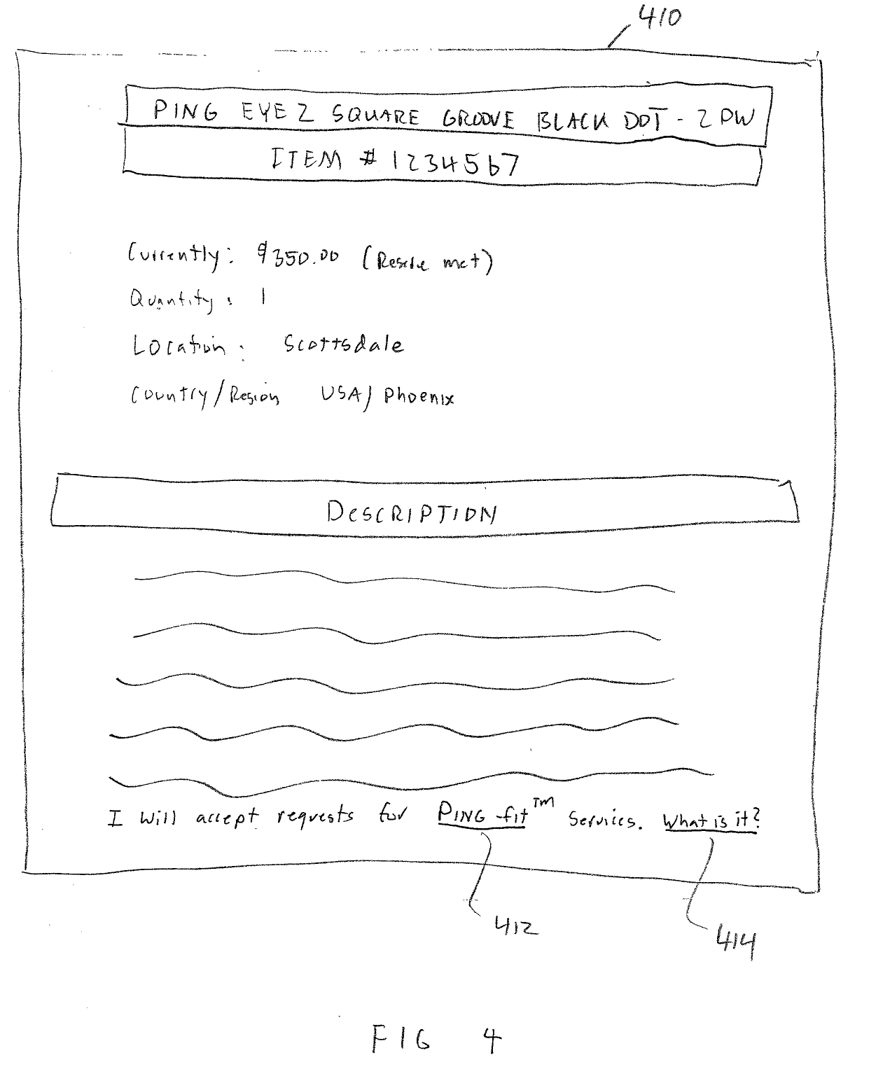

FIG. 4 is an illustration of a webpage displayed on the client system of a potential bidder in accordance with an alternative embodiment in accordance with the present invention.

### DETAILED DESCRIPTION

FIG. 1 illustrates the general architecture of a system for marketing in-transit services in accordance with the present invention. The system includes a client system 116 of a seller together with an associated browser 114 as well as a client system 120 of a bidder together with an associated browser 122. The system further includes a website 112 of an on-line auction having an associate webserver host system 110 and a manufacturer website 132 having an associated webserver host system 130. Each of the aforementioned systems are interconnected through a distributed collection of interconnected (public and/or private) networks linked together by a set of standard protocols (such as transfer control protocol/internet protocol “TCP/IP” and hypertext markup language “HTML”) to form a global distributed network commonly known as the Internet. Browsers 114 and 122 comprise standard web browsers such as Microsoft Internet Explorer or Netscape Navigator which use the HTTP protocol to communicate with the webserver host systems 110 and 130 of the on-line auction and manufacturer websites.

FIG. 2 is an illustration of a webpage 210 displayed on the client system 116 of a seller posting an item for sale on an on-line auction website. The illustrative example webpage 210 is sent by the host system webserver 110 of the on-line auction website 112 in response to a request from the browser 114 of the seller's client system 116 and is conventionally formatted in hypertext markup language (HTML) for display on the browser 114. Preferably the webpage 210 is an interactive form translated by a common gateway interface (CGI) such that the data entered by the user into the client system 116 is formatted for storage in the storage media 118 of on-line auction website 112. In addition to the information collected by webpage 210 concerning the to type of goods being sold, location, minimum bid, reserve, etc. webpage 210 provides a field in which the seller can authorize in-transit certification, fitting and repair. In the illustrative example fields 212, 214 and 216 permit the seller to indicate whether in-transit certification fitting and repair is authorized if the buyer pays (field 212), the seller pays (field 214), or is not authorized (field 216). The information entered into webpage 210 is stored in storage device 118 of on-line auction website 112 and used to generate a webpage for viewing by a browser 122 of client system 120 of a potential bidder.

FIG. 3 is an illustration of a webpage 310 describing an item available for auction based on the information inputted via webpage 210 of FIG. 2. Webpage 310 displays conventional information such as the title of the item(s) offered for sale, the item number, the current bid, whether the reserve has been met, quantity, location and a detailed description of the item(s) being offered. Additionally, webpage 310 displays a button 312 that, in accordance with the selection made by the seller indicated in field 212 of webpage 210, permits the buyer to purchase the in-transit certification fitting and repair services offered by the manufacturer, such as Ping, Inc. A hyperlink 314 proximal button 312 provides a hyperlink to a webpage resident on either storage device 118 of the host system 110 of on-line auction website 112 or on storage device 128 of host system 130 of manufacturer's website 132. The hyperlinked webpage (not shown) provides the potential bidder with information of a general nature concerning the services offered by the manufacturer should the in-transit recertification, fitting and repair services be selected.

FIG. 4 is an illustration of an alternative embodiment of a webpage displaying an item for auction. In the event the auction site 112 does not support the addition of button 312 and hyperlink 314 a potential seller can include hyperlinks 412 and 414 in the body of the description (over which the seller has complete control). Hyperlinks 412 and 414 can be cut and pasted by the seller from the manufacturer's website. The function of hyperlink 414 is directly analogous to the function of hyperlink 314 of webpage 310 and hyperlink 412 has the analogous function to button 312 of webpage 310.

If the potential bidder requests the in-transit services either by clicking on button 312, hyperlink 412 or otherwise, a request is issued by browser 122 of client system 120 to host system 130 of manufacturer's website 132 for delivery of an interactive form into which the potential bidder enters information, such as serial number of the clubs, factory loft and lie (for Ping clubs, this is indicated by a color code, black dot, red dot, green dot, etc.), the bidder also enters personal data such as name, address, height, wrist-to-floor length, finger length, etc.) and the desired services (e.g. authentication, static fitting, new grips, new shafts, etc.) and optionally the potential bidders credit card number. Host system 130 provides an HTML document to browser 122 describing the factory original specifications of the clubs based on the serial number entered by the potential bidder. Host system 130 further provides a price quote for the services requested. The factory specifications permit the bidder to compare the factory original specifications with the detailed description posted by the seller to determine whether any radical changes have been made to the clubs, such as reshafting with an incorrect type of shaft. Additionally, where the services requested are impracticable, such as a request to install graphite shafts in clubs originally equipped with steel shafts (which would result in incorrect swing weights) the HTML document provided by host system 130 to browser 122 would indicate via a dialogue box or otherwise that the requested services would create a compatibility problem.

Once the potential bidder has successfully completed the request, a unique identifier is stored either as a cookie on storage device 124 of client system 120 or on storage device 118 of host system 110 of on-line auction website 112. Detailed information concerning the requested services and identity of the bidder is stored on storage device 128 of host system 130 of manufacturer along with a reference to the auction item number of the goods being sold.

In an alternative embodiment, if the potential bidder requests the in-transit services either by clicking on button 312, hyperlink 412 or otherwise, a cookie is stored on the bidder's system indicating that the bidder has requested in-transit services. After the auction has closed and the bidder is determined to be successful bidder, the host system 110 notifies the bidder that he or she is the successful bidder and, based on the information stored in the cookie, causes browser 122 of client system 120 to issue a request to host system 130 of the manufacturer's web site 132 to deliver an interactive form to browser 122 for inputting the specific services required by bidder. In the alternative embodiment, less information needs to be stored on storage device 128 of host system 130, however, the bidder does not know the cost of the in-transit services until after the auction has closed. In a further alternative embodiment, some combination of information (such as the factory specifications of the clubs and the price of “standard” authentication can be provided to the bidder) is provided to the bidder before the auction closes (which would not require storage of bidder information on storage device 128) and the remaining information is collected from the winning bidder after the auction closes.

Once the auction closes, the host system 110 of on-line auction website 112 notifies host system 130 of the manufacturer that the auction for the item has closed. In the event the high bidder did not select the in-transit services, host system 130 deletes all records relating to requests for in-transit services of the goods offered under that auction item number. In the even that the high bidder did select the in-transit services, as indicated by the cookie stored on client system 122 or host system 110 of the on-line auction website, host system 130 of manufacturer sends an HTML document or email message to client system 120 of the successful bidder, notifying him or her that he or she was the successful bidder. Host system 130 further provides the final purchase price, including the in-transit services, shipping, etc. and, if not previously submitted, requests the bidder's credit card or other payment information. Alternatively, host system 130 can provide pricing information to host system 110 of on-line auction website 112 and some or all of the price and shipping information can be transmitted to the client system 120 of the successful bidder directly from host system 110 of on-line auction website 112.

Additionally, host system 110 of on-line auction website also automatically sends an email to host system 130 of manufacturer giving the seller's name and contact information. Host system 130 of manufacturer in turn automatically sends an email to client system 116 of seller providing the manufacturer's shipping address and instructing the seller in accordance with the bidder's request, to ship the goods to the manufacturer. Upon manufacturer's receipt and inspection of the item(s) to verify authenticity, the manufacturer forwards the bid price together with any shipping to the bank account of the seller or such other payment method as the seller indicated would be acceptable in the original listing with online auction website 112. The manufacturer then performs the requested services and ships the item or items to the successful bidder.

Although certain illustrative embodiments and methods have been disclosed herein, it will be apparent from the foregoing disclosure to those skilled in the art that variations and modifications of such embodiments and methods may be made without departing from the spirit and scope of the invention. For example, in the illustrative embodiment the manufacturer acts as an escrow agent receiving funds from the successful bidder and forwarding them to the seller upon receipt and inspection of the auctioned item(s). Other methods of handling payment such as direct payment of the purchase price to the seller and direct payment for the in-transit services to the manufacturer as well as a third party escrow or escrow by the operator of the on-line auction are within the scope of the present invention. Additionally, in lieu of the manufacturer performing the services directly from a central location, services such as fitting could be performed by a factory authorized local shop based on the bidder's zip code or other location information. Accordingly, it is intended that the invention shall be limited only to the extent required by the appended claims and the rules and principles of applicable law.

What is claimed is:

1. A method of selling factory authorized services for goods sold to a bidder by a seller through an on-line auction comprising:
displaying on a client system of a bidder, information identifying an item being auctioned;
displaying in conjunction with said information identifying said item being auctioned, an option for the bidder to request factory authorized services for said item being auctioned;
in response to an input from the client system of the bidder indicating that factory authorized services are desired, electronically providing to the client system of the bidder a request to provide information specifying the services required;
determining the successful bidder for the item being auctioned and, if the successful bidder has requested factory authorized services, electronically providing to the client system of the seller directions to ship the item being auctioned to a factory authorized service facility; and
receiving the item being auctioned at the factory authorized service facility, performing the services identified by the successful bidder and shipping the item being auctioned to the bidder.

2. The method of claim 1 further comprising:
receiving at a host system the information specifying the services required;
electronically providing to the client system of the bidder a cost estimate for the services required.

3. The method of claim 1, further comprising:
storing a unique indicator for the bidder requesting factory services indicating that the bidder has requested factory services.

4. The method of claim 3, further comprising:
storing information specifying the factory services requested in a storage device separate from the unique indicator for the bidder requesting factory services.

5. The method of claim 1 further comprising:
receiving address information from the bidder; and
providing a referral to a local dealer for factory authorized services.

6. The method of claim 3 wherein:
The step of storing is by means of a cookie on the client system of the bidder.

7. A method of selling factory authorized services for goods sold to a bidder by a seller through an on-line auction comprising:
displaying on a client system of a bidder, information identifying an item being auctioned;
displaying in conjunction with said information identifying said item being auctioned, an option for the bidder to request factory authorized services for said item being auctioned;
storing, in response to an input from the client system of the bidder, an identifier indicating that the user of the client system has requested factory authorized services;
determining the successful bidder for the item being auctioned and if the successful bidder has requested factory authorized services, electronically providing to the client system of the successful bidder a request to identify the services required and shipping information;
electronically providing to the client system of the seller directions to ship the item being auctioned to the factory service facility; and
receiving the item being auctioned at the factory service facility, performing the services identified by the successful bidder and shipping the item being auctioned to the bidder.

8. The method of claim 7 wherein:
the step of storing is by means of a cookie on the client system of the bidder.

9. The method of claim 7 wherein:
the step of storing is a host server of an on-line auction.

10. The method of claim 7 wherein:
The item being auctioned is a golf club.

11. The method of claim 10 wherein:
In response to said input from the client system of the bidder indicating that factory authorized services are desired, electronically providing the client system of the bidder a request for information concerning the serial number, shaft type, loft and lie of said golf club being auctioned and the type of factory services desired;
transmitting said information to a web server of a merchant offering said factory authorized services;
determining, based upon said information, whether the factory authorized services desired are feasible and an estimate of the cost of such factory services; and
transmitting the results of said determination and said estimate of cost to the client system of the bidder.

12. The method of claim 10, wherein, said request for information is an electronic form.

13. The method of claim 10, further comprising:
receiving and inspecting the item being auctioned; and
releasing funds to the seller once the inspection has been satisfactorily completed.
